(19) United States
(12) Patent Application Publication
(10) Pub. No.: US 2007/0025889 A1
(43) Pub. Date: Feb. 1, 2007

(54) Reactors, reactor assemblies and production processes

(75) Inventors: Janet Boggs, Brownsburg, IN (US); Stephan Brandstadter, Indianapolis, IN (US); Mitchel Cohn, West Lafayette, IN (US); Stephen Owens, White Pine, TN (US)

Correspondence Address: Chemtura Corporation;c/o Michael P. Dilworth, Benson Road, Middlebury, CT, 06749, US

(73) Assignee: PCBU Business Services, Inc.

(21) Appl. No.: 11/192,831

(22) Filed: Jul. 28, 2005

(51) Int. Cl. B01J 19/00; C01B 7/00

(52) U.S. Cl. 422/129; 422/225; 422/186.3; 423/462

(57) ABSTRACT

Reactors including a chamber having a mixing apparatus within the chamber are provided. Reactors are also provided that include a chamber with a separation apparatus and/or a catalyst apparatus within the chamber. Reactor assemblies are provided that can include: a base configured to define at least a portion of a reaction chamber volume, a separation apparatus within the reaction chamber volume, a catalyst apparatus within the reaction chamber volume, and a lid coupled to both the separation and catalyst apparatuses. Production processes are provided that can include combining at least two reactants within a chamber to form a gas-phase reaction mixture and mechanically mixing the mixture within the chamber to form a product.

### TECHNICAL FIELD

The present disclosure relates to reactors, reactor assemblies and production processes. Exemplary embodiments described in the present disclosure relate to gas-phase reactors, reactor assemblies, and/or gas-phase production processes.

### BACKGROUND OF THE INVENTION

Chemical production processes can utilize reactors to produce products. Exemplary production processes can combine reactants within the reactors to form a reactant mixture. Some processes combine reactants in the gas-phase and expose the reaction mixture to a catalyst such as uv radiation. Exemplary reactors configured to catalyze utilizing uv radiation typically include multiple reactors with each reactor having an individual light well to provide the uv radiation. With respect to most processes, reactant mixtures are removed from the reactor and the product separated from the reactant mixture outside the reactor.

The present disclosure provides reactors, reactor assemblies, and production processes that, according to exemplary embodiments, offer improvements over the state of the art.

### SUMMARY OF THE INVENTION

Reactors including a chamber having a mechanical-mixing apparatus within the chamber are provided. Reactors having a chamber with a separation apparatus and/or a catalyst apparatus within the chamber are also provided.

Reactor assemblies are also provided that can include a base configured to define at least a portion of a reaction chamber volume, a separation apparatus configured to perform chemical separation within the reaction chamber volume, a catalyst apparatus configured to perform catalysis within the reaction chamber volume, and a lid coupled to both the separation and catalyst apparatuses. The lid can be configured to be removably operably coupled with respect to the base. The lid can be configured to be positioned in a first operable position to form a seal with the base and provide the apparatuses at least partially within the reaction chamber volume. The lid can also be configured to be positioned in a second operable position with at least a portion of the lid spaced from the base and the apparatuses at least partially removed from the reaction chamber volume.

Production processes are provided that can include combining at least two reactants within a chamber to form a gas phase reaction mixture and mechanically mixing the mixture within the chamber to form a product.

### BRIEF DESCRIPTION OF THE DRAWINGS

FIG. 1 is a production system according to an embodiment.

FIG. 2 is a reactor according to an embodiment.

FIG. 3 is a mixing apparatus of the reactor of FIG. 2 according to embodiment.

FIG. 4 is a component assembly of the reactor of FIG. 2 according to an embodiment.

FIG. 5 is an assembly of the reactor of FIG. 2 according to an embodiment.

FIG. 6 is a detailed view of the assemblies of FIGS. 4 and 5 according to an embodiment.

FIG. 7 is a component assembly of the reactor of FIG. 2 according to an embodiment.

FIG. 8 is a component assembly of the reactor of FIG. 2 according to an embodiment.

FIG. 9 is a top view of the component assemblies of FIGS. 4 and 7 according to an embodiment.

FIG. 10 is a production system according to an embodiment.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

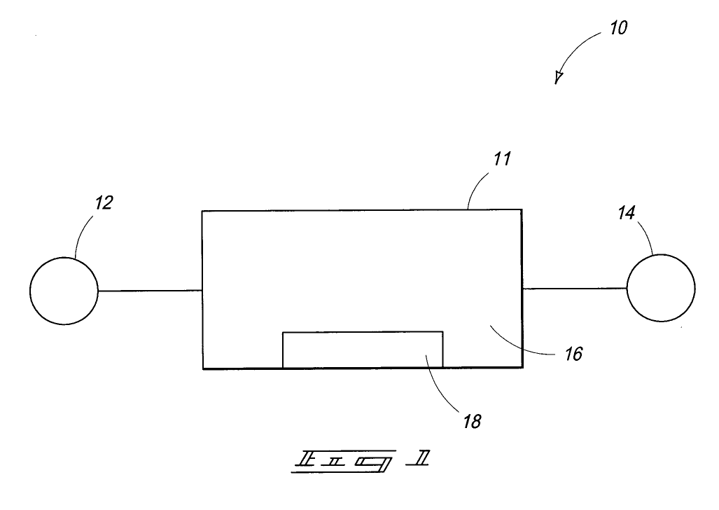

Reactors, reactor assemblies and processes are described with reference to FIGS. 1-9. Referring first to FIG. 1, an exemplary system 10 is shown that includes a reaction chamber 11 coupled to a reactant inlet 12 and a product outlet 14. Reaction chamber 11 includes an interior volume 16 and a mixing apparatus 18 within volume 16. Chamber 11 can be constructed of reaction-inert materials such Hastelloy C and/or plastics such as polytretrafluoroethylene (PTFE) and/or perfluoroalkoxy (PFA) plastics, for example. According to an exemplary embodiment, reaction chamber 11 can be configured as a gas-phase reactor and as such may be configured to perform halogenation reactions including addition as well as photohalogenation reactions in the gas-phase, for example. Chamber 11 may also be configured as a photochemical reactor as well.

Within volume 16, reactants can form a reaction mixture that can include reactants alone or in combination with products and/or by-products. When configured as a gas-phase reactor, an entirety of the reactants can be in the gas-phase and/or at least a portion of the reaction mixture can be in the gas-phase. The portion of the reaction mixture in the gas-phase can include an entirety of the reactants. For example, reactants received from reactant inlet 12 can be in the gas-phase within volume 16 and products and/or by-products can be in the liquid phase. Reaction chambers can be jacketed with a temperature regulation apparatus such as heat tape and/or tubing supplying temperature regulating fluids such as glycols and/or water, for example. The temperature regulation apparatus can be configured to maintain the reactants within the reaction chamber in the gas-phase while the reaction mixture is mixed within the chamber.

Mixing apparatus 18 can be configured to mix the reactants within the volume of reaction chamber 11. The mixing can facilitate the formation of the reaction mixture. Apparatus 18 can be configured as a dispersing mixer to distribute reactants within the volume of chamber 11 with such distribution creating a uniform distribution of the reactants throughout the volume. Apparatus 18 can be configured swirl, cut, and/or fold the reactants using moving parts such as rotating parts. The mixing can stress the reactants according to one or more of shear, extension, and/or impact mechanisms, for example.

Exemplary mixing apparatus 18 include but are not limited to mechanical-mixing apparatuses. Apparatus 18 can be configured as impellers coupled to a rotating shaft driven by a motor, for example. Exemplary mechanical-mixing apparatus include fans, such as turbine type fans. The blades of the fan are exemplary of impellers. Apparatus 18 can also be configured as a high-shear mixer. Exemplary high-shear mixers include those mixers having an impeller proximate a wall to facilitate a shear action between the impeller and the wall.

Apparatus 18 can implemented to mix gas-phase reactants of a reaction mixture and facilitate increased production of products of the reactants. Apparatus 18 can be approximate the bottom and/or lower portion of reaction chamber 10. In exemplary embodiments apparatus 18 can be below a separation apparatus not shown in FIG. 1, but depicted in the figures that follow. Mixing apparatus 18 can be constructed of reactant-inert materials such as Hastelloy C and/or plastics such as polytretrafluoroethylene (PTFE) and/or perfluoroalkoxy (PFA) plastics, for example.

Exemplary reactants that can be processed utilizing reaction chamber 11 include but are not limited to halogenation reagents and carbon-comprising compounds. Exemplary halogenation reagents include those containing hydrogen such as HBr, HCl, and/or HF as well as diatomic reagents such as Br₂, Cl₂, and/or F₂, for example. Exemplary carbon-comprising compounds can be saturated or unsaturated and as such can include olefins and/or aliphatic compounds. Carbon-comprising compounds can also include fully and or at least partially hydrogenated compounds such as hydrocarbons and/or ethers. The carbon-comprising compounds can also contain halogens such as fluorine, for example. Exemplary carbon-comprising compounds can include vinylidene difluoride (1,1-difluoroethene, VDF), trifluoropropene, hexafluoropropene, vinyl fluoride (fluoroethene), and/or ethers such as C3-C5 ethers including but not limited to ethyl-methyl ethers, propyl-methyl ethers, and/or butyl-methyl ethers.

According to exemplary implementations, within reaction chamber 11, a halogenation reagent such as HBr can be combined with a carbon-comprising compound such as vinylidene difluoride to form a reaction mixture comprising both HBr and vinylidene difluoride. Reaction chamber 11 can be maintained at from about 21 to about 23° C. and about 1020 to about 1280 Torr to maintain at least a portion of the reaction mixture in the gas-phase. Apparatus 18 may be engaged to mix the reaction mixture and form the product bromodifluoroethane that may be recovered via product outlet 14. The reaction of reactants within chamber 11 may be catalyzed with radiation such as uv radiation including radiation at 254 nm using a RUL-2537 Å Lamp(Southern New England Ultraviolet Company, 954 Newfield Street, Middletown, Conn.).

As another example, within reaction chamber 11, a halogenation reagent such as HBr can be combined with a carbon-comprising compound such as vinyl fluoride to form a reaction mixture comprising both HBr and vinyl fluoride. Reaction chamber 11 can be at a temperature sufficient to maintain the at least a portion of the reaction mixture in the gas-phase. Apparatus 18 may be engaged to mix the reaction mixture and form the product bromofluoroethane that may be recovered via product outlet 14. The reaction of reactants within chamber 11 may be catalyzed with radiation such as uv radiation including radiation at 254 nm.

As still another example, within reaction chamber 11, a halogenation reagent such as Cl₂ can be combined with a carbon-comprising compound such as an ether to form a reaction mixture comprising both Cl₂ and ether. Exemplary reaction conditions are described in U.S. Pat. No. 6,849,194 filed May 12, 2003, entitled Methods for preparing ethers, ether compositions, fluoroether fire extinguishing systems, mixtures and methods, the entirety of which is incorporated by reference herein. Reaction chamber 11 can be at a temperature sufficient to maintain the portion of the reaction mixture in the gas-phase. Apparatus 18 may be engaged to mix the reaction mixture and form the chlorinated ether product that may be recovered via product outlet 14. The reaction of reactants within chamber 11 may be catalyzed with radiation such as radiation at 350 nm.

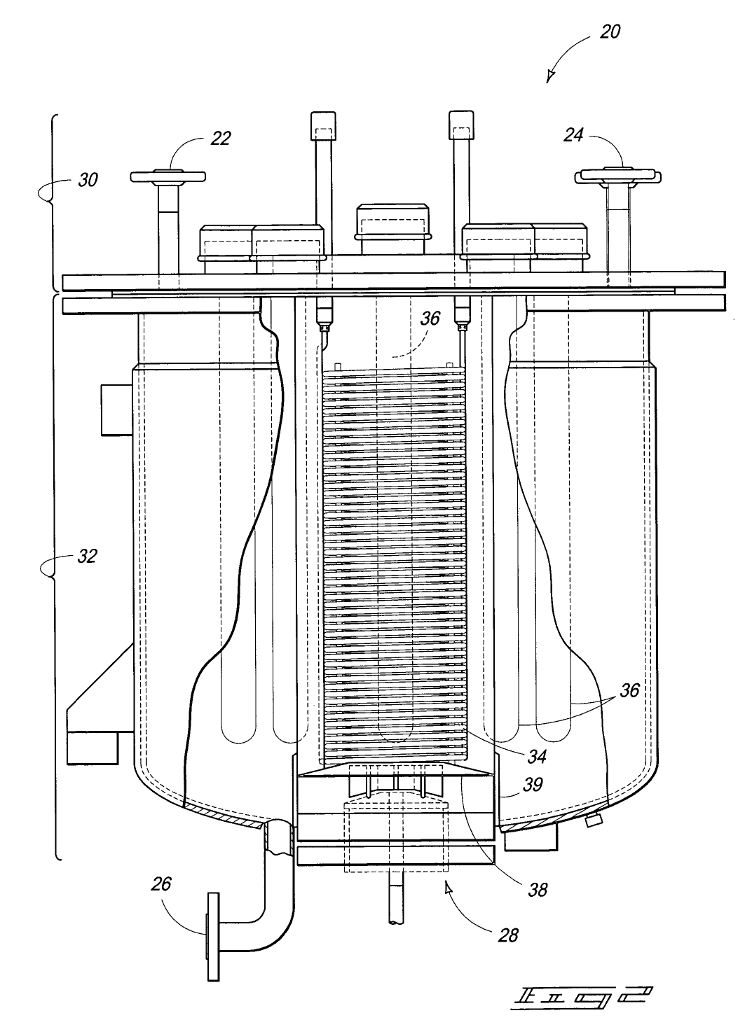

Exemplary and alternative embodiments of reaction chamber 11, as well as assemblies and processes, are described with reference to FIG. 2-9. The described exemplary and alternative embodiments are not be considered exhaustive for at least that reason that upon review of this disclosure additional alternative embodiments to those disclosed will be envisioned by those of ordinary skill in the art.

Referring to FIG. 2, an exemplary reaction chamber 20 is shown that includes reactant inlets 22 and 24 as well as product outlet 26. As shown, chamber 20 can be configured as a gas-phase reactor to receive at least two reactants via inlets 22 and 24. One or both of reactant inlets 22 and 24 may be configured to include dip tubes extending into the volume of chamber 20. The tubes may be configured to extend from an upper portion of the chamber to a center portion of the chamber, for example. Exemplary configurations include tubes that extent from an upper portion to a lower portion of the chamber traversing a center portion of the chamber. In accordance with the depicted configuration of FIG. 2, at least one reactant inlet can be located at an upper portion of chamber 20 and the product outlet can be located at a lower portion.

As exemplarily depicted in FIG. 2, reaction chamber 20 can be configured as an assembly comprising multiple components. For example, reaction chamber 20 can include a lid component 30 and a base component 32. Lid and base components can be constructed of and/or lined with reactant-inert materials such as Hastelloy C and/or plastics such as polytretrafluoroethylene (PTFE) and/or perfluoroalkoxy (PFA) plastics, for example. Lid component 30 can be configured to be removably operably coupled with respect to base component 32. Chamber 20 can be configured to be in a first operable position with lid component 30 operatively sealing with base component 32. Operatively sealing lid component 30 to base component 32 can include fastening lid component 30 to base component 32 via nuts and bolts, for example. In this first operable position, chamber 20 can define an interior volume configured to receive and react reactants. According to exemplary configurations the interior volume can be at least about 200 liters. Chamber 20 can also be configured to be in a second operable position with lid component 30 spaced from base component 32. In this second operable position, the interior volume of chamber 20 may be accessed to facilite maintenance of mixing apparatus 28, for example.

As exemplarily depicted, chamber 20 also includes a mixing apparatus 28 located at the lower portion and/or bottom of reaction chamber 20 and as shown the mixing apparatus can be a mechanical-mixing apparatus such as a turbine-type fan. While chamber 20 has been depicted as an assembly of components with mixing apparatus 28 coupled to base component 32, such configuration is not necessary as mixing apparatus 28 may be coupled with reaction chambers having alternative configurations.

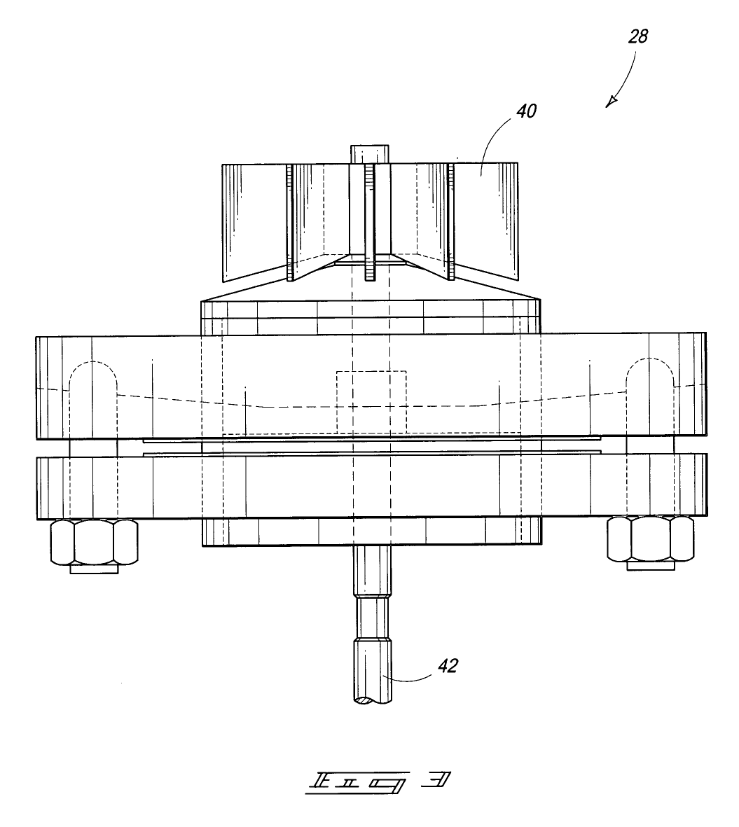

Referring to FIG. 3 a more detailed view of mixing apparatus 28 is shown with fan 40 coupled to a fan motor (not shown) via an axle 42. Mixing apparatus 28 can be configured to couple to a reaction chamber such as reaction chamber 11 and/or 20. Such exemplary coupling can include fastening the apparatus to an interior portion of the chamber via nuts and bolts for example.

Referring again to FIG. 2, reaction chamber 20 can include separation apparatus 34 and/or catalytic apparatus 36. In the exemplary depicted embodiment of FIG. 2, separation apparatus 34 and/or catalytic apparatus 36 can be coupled to lid component 30 of reaction chamber 20. Separation apparatus and/or catalytic apparatus may also be coupled to an interior wall of the reaction chamber and extend into the volume of the chamber.

In exemplary implementations, separation apparatus 34 can be configured as a cold finger such as coiled tubing extending to within the volume of reaction chamber 20. Apparatus 34 may also be configured to line at least a portion of an interior wall of chamber 20, for example. Apparatus 34 can be coupled to lid component 30 and extend substantially perpendicularly from component 30 and/or traversing the centermost region of the volume of reaction chamber 20 in the first operable position. Apparatus 34 can extend from an uppermost portion of the reaction chamber to a lowermost portion of the chamber as well.

Apparatus 34 can be configured to define a space within the volume of the reaction chamber. When configured as coiled tubing for example, the tubing can be configured to define a cylinder having a interior volume. In exemplary implementations, the interior volume of the cylinder can include the space within the chamber defined by apparatus 34. The coils of apparatus 34 can be configured to contain a fluid having a predetermined temperature. The fluid can include water, glycols, and/or mixtures of water and glycols such as a 50/50 mix of water and ethylene glycol, for example. The fluids may be chilled to facilitate the condensing of the product on the apparatus. The fluids may be provided through the coils at a rate of about 2.3 to about 4.2 L/min. For example, apparatus 34 can be maintained at a temperature above the boiling points of the reactants at the pressure within the reaction chamber; but below the boiling point of product. For example, where HBr and vinylidene difluoride are the reactants and bromodifluoroethane is the product, separation apparatus 34 can be maintained at between from about ⁻25° C. to about ⁻5° C. to condense the bromodifluoroethane product on separation apparatus 34.

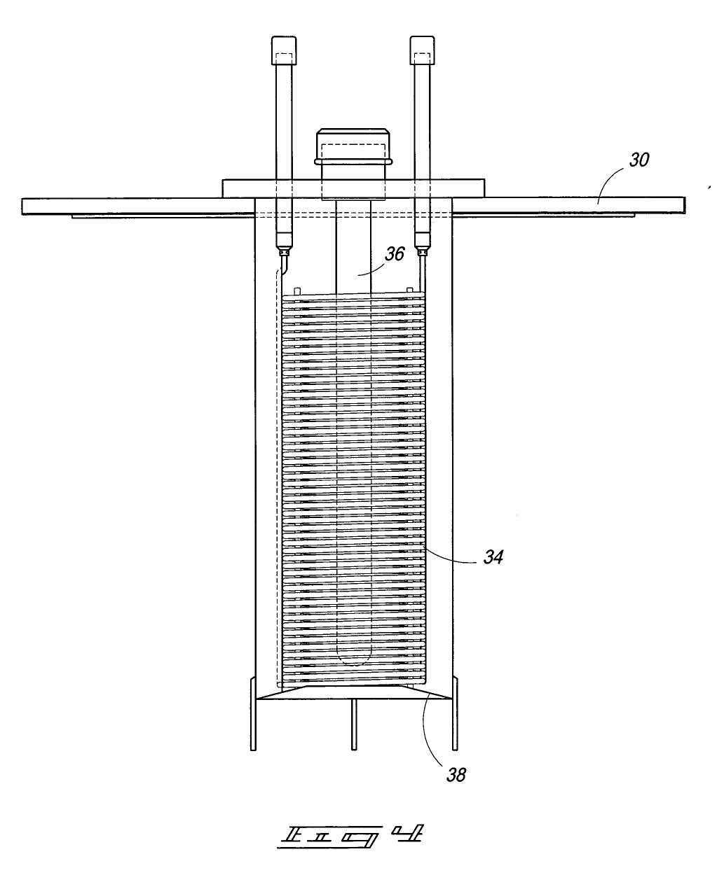

As exemplarily depicted in FIGS. 2 and 4, separation apparatus 34 can be coupled to lid component 30. As stated above, lid component can be removably operably coupled to base component 32. As exemplarily depicted in FIGS. 2 and 4, in the first operable position separation apparatus 34 is at least partially within the volume of reaction chamber 20. As described above, in the first operable position, apparatus 34 can define a space within the volume of chamber 20. Apparatus 34 may also be above mixing apparatus 28, for example, laterally aligned above mixing apparatus 28 and/or separated from mixing apparatus 28 by a shield assembly 38.

Referring to FIG. 4, exemplary embodiments include the extension of separation apparatus 34 vertically from a top portion of reaction chamber 20 through to a bottom portion of reaction chamber 20. Referring to FIG. 4, an exemplary depiction of separation apparatus 34 coupled to lid component 30 is shown. In exemplary embodiments, apparatus 34 can be aligned above shield 38. Shield 38 can be configured as a component of mixing apparatus 28 and as such can be constructed of reactant-inert materials such as Hastelloy C and/or plastics such as polytretrafluoroethylene (PTFE) and/or perfluoroalkoxy (PFA) plastics, for example. Shield 38 can be configured to divert separated product from above mixing apparatus 28 to recovery outlet 26. In exemplary implementations, shield 38 and/or separation apparatus 34 can be configured to couple. When apparatus 34 is configured as a coil of tubing defining a cylinder for example, shield 38 can be fabricated with a narrow portion configured to extend into the volume of the cylinder, for example. In the first operable position, referred to above, apparatus 34 may couple with shield 38.

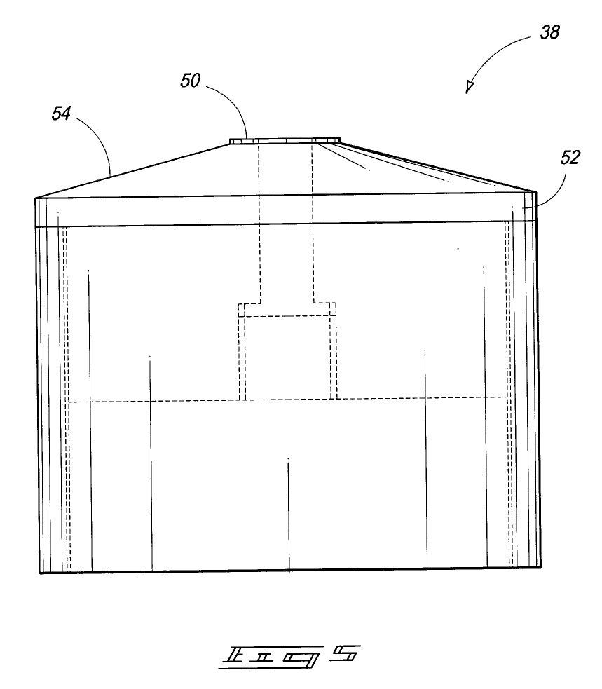

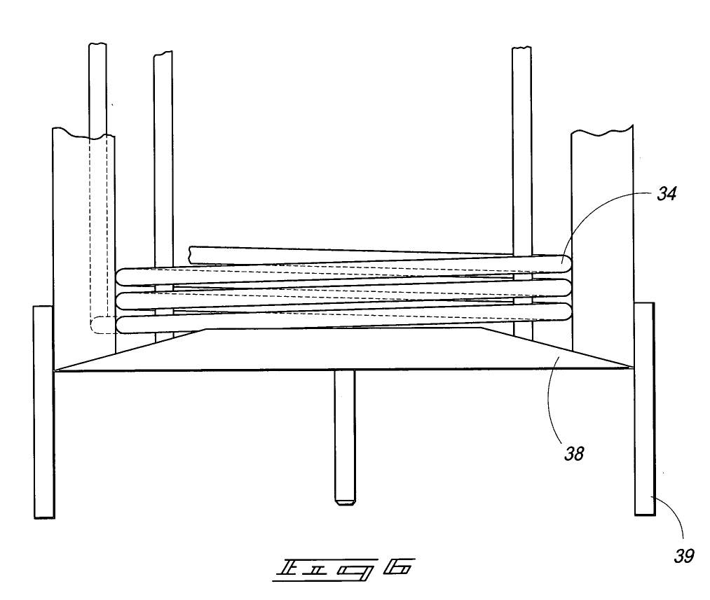

Referring to FIG. 5, a more detailed view of an exemplary shield 38 is shown having an upper portion 50 connected to lower portion 52 via roofing portion 54. The connection of upper portion 50 to lower portion 52 can be configured to cover mixing apparatus 28 and prevent product 26 from contacting mixing apparatus 28 during operation of reaction chamber 20. For example, as shown portion 54 is angled from top portion 50 and lower portion 52. Portions of shield 38 may also be coupled with product outlet 26 to facilitate recovery of at least a portion of the product separated from the reaction mixture within chamber 20. As shown, portion 50 has also been fabricated to be sufficiently narrow to be received by the volume of the cylinder of coiled tubing. The exemplary coupling of separation apparatus 34 and shield 38 is shown in greater detail with reference to FIG. 6. As shown in FIG. 6, mixing apparatus 28 can reside within a flange 39, the flange having openings to facilitate the mixing of the reaction mixture, and shield 38 can extend to flange 39.

According to exemplary implementations, apparatus 34 may be configured as a cylinder of coiled tubing and that is laterally aligned over apparatus 28. When implemented in this fashion, apparatus 34 can facilitate the flow of reactants in a draft tube like manner in combination with apparatus 28. Configuring shield 38 between apparatus 34 and apparatus 28 in this configuration can further facilitate the mixing of reactants with chamber 20.

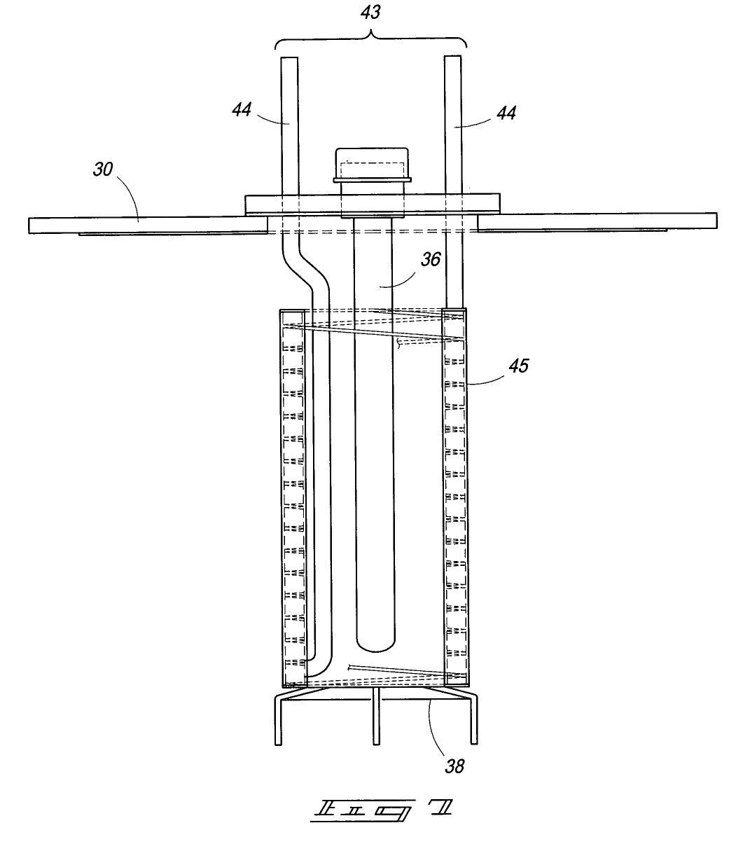

Referring to FIG. 7, the separation apparatus can be configured as a “two pipe” system 43. In this configuration tubing 44 can extend from component 30, in the first operable position, into the volume of the chamber. Tubing 44 can be configured to contain a fluid that may be temperature controlled such as the water and glycols fluids mentioned previously. Tubing 44 can be configured with baffles 45. Baffles 45 can take the form of channels extending between tubing 44. The channels can be configured to couple with tubing 44 and receive fluid from tubing 44. Additional embodiments include tubing extending between tubing 44 in a spiral fashion, for example. Baffles 45 can define a cylinder having an internal volume with catalytic apparatus 36 extending therein. In exemplary embodiments, tubing 44 can provide fluid to baffles 45 at a lower portion of baffles 45 and circulate the fluid through the baffles for removal at an upper portion of baffles 45. System 43 can be configured to reside laterally over shield 38 in the first operable position.

Referring again to FIG. 2, catalytic apparatus 36 is shown coupled to an interior portion of reaction chamber 20 such as lid component 30. As exemplarily depicted, apparatus 36 can be a plurality of light wells extending into the volume of the reaction chamber when lid component 30 is in the first operable position. Individual light wells may be constructed of quartz or any material suitable for transmitting radiation to within chamber 20. Exemplary radiation includes visible light, microwaves, infrared (IR), and/or radio frequency (RF). The light wells can be configured to expose reactants within chamber 20 to uv radiation such as 254 nm for example. Such uv radiation may be provided through lid component 30 as drop-in lights into lightwells, for example. Multiple configurations of the catalytic apparatus in combination with separation apparatus are provided. For example, as described above, the separation apparatus may be configured to define a space within the reaction chamber. In combination with this configuration of the separation apparatus, the catalytic apparatus may be configured to extend within the space defined by the separation apparatus such as apparatus 36 of FIG. 4 extending to within the volume of apparatus 34.

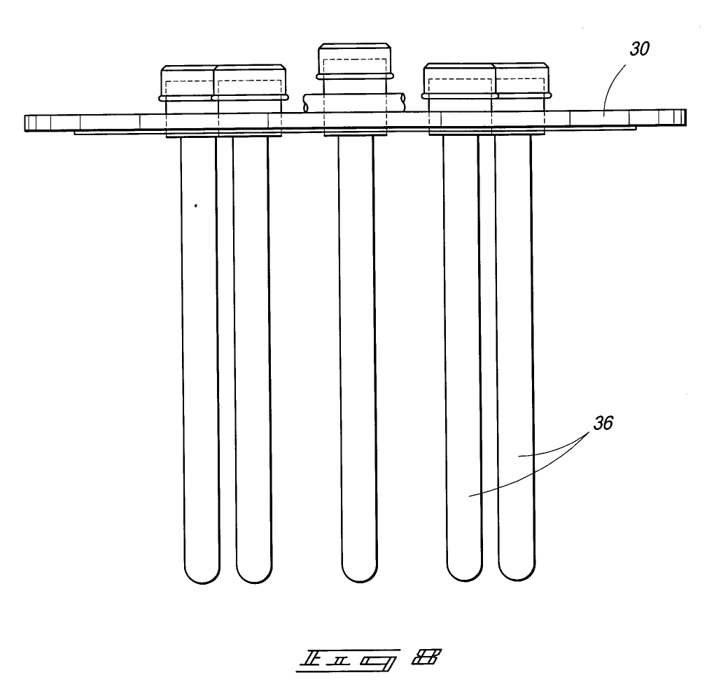

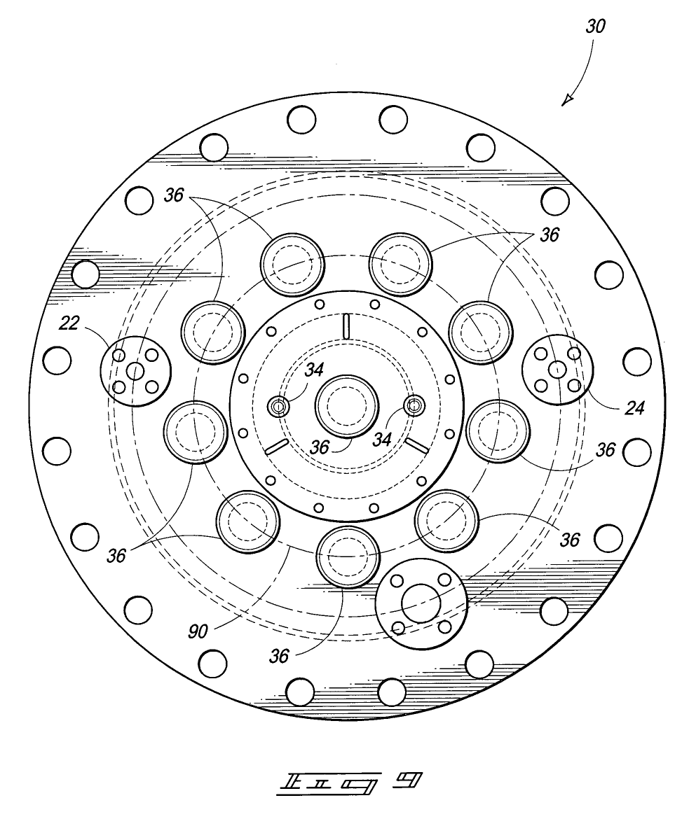

As another example, the catalytic apparatus may be configured to define a perimeter around the space defined by the separation apparatus. Referring to FIG. 8 in combination with FIG. 9, lid component 30 is shown having catalytic apparatus 36 extending therefrom. As shown, catalytic apparatus 36 can include a plurality of light wells extending perpendicularly from component 30. Referring to FIG. 9, a top view of lid component 30 is shown. As shown, catalytic apparatus 36 can be aligned at points along a perimeter 90 around separation apparatus 34 such as to encircle apparatus 34. As an exemplary configuration, catalytic apparatus 36 can be proximate the outer side walls of reaction chamber 20 and/or proximate separation apparatus 34. Separation apparatus 34 can be coupled to lid component 30 at approximately the center of perimeter 90. These combinations are exemplary of configurations of apparatuses 28, 34, and 36 that can facilitate mixing of reactants 22 and 24 as well. For example, and by way of example only, configurations of chamber 20 having apparatus 34 laterally aligned over apparatus 28 with apparatus 36 defining a perimeter around apparatus 34 can facilitate a torodial circulation pattern with chamber 20 that may ensure homogenous mixing of the reactants.

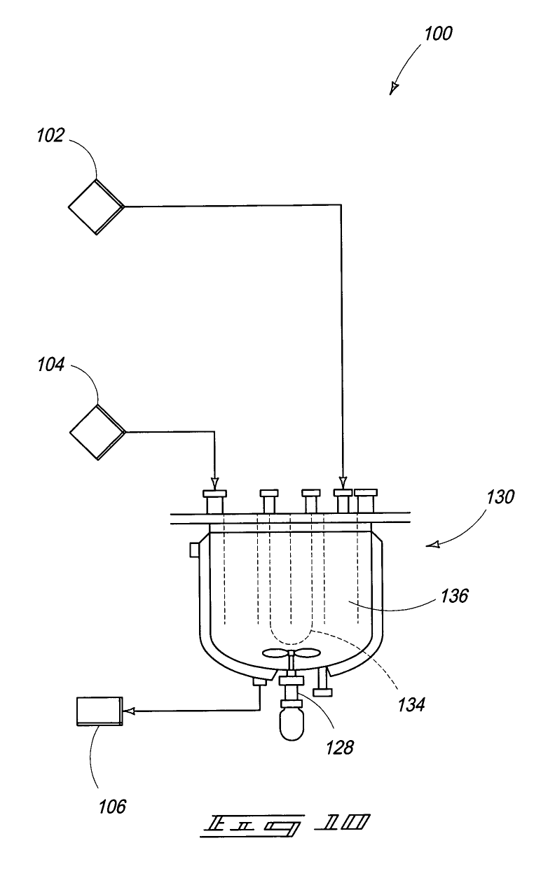

Referring to FIG. 10, an exemplary system 100 is shown including exemplary reaction chamber 130 configured to combine reactants 102 and 104. According to exemplary embodiments reactant 102 can include HBr and reactant 104 can include vinylidene difluoride. Reactants 102 and 104 can be combined within reaction chamber 130 to form a reaction mixture. From this reaction mixture, reaction chamber 130 can be heated and catalytic apparatus 136 can facilitate the production of product 106. Product 106 which can be recovered from reaction chamber 130 utilizing separation apparatus 134. In exemplary embodiments the reaction mixture of reactants 102 and 104 may be mechanically mixed using mechanical mixing apparatus 128. Product 106 can include bromodifluoroethane. In exemplary embodiments reactants 102 and 104 can be heated to from about 21-23° C. and provided to reaction chamber 130 at a mole ratio of the vinylidene difluoride to HBr of at least 1:1 and in exemplary embodiments of 1.1:1. Separation apparatus 134 can be configured at from about ⁻25-⁻5° C. and catalytic apparatus 136 can include lightwells for uv radiation of 254 nm. Product 106 can be condensed on the coils of separation apparatus 134 and recovered below the coils. Product 106 can be washed with caustic. Exemplary caustic includes water and KOH and this washed product dried using mole sieve and then finally distilled to yield a bromodifluoroethane product.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A gas-phase reactor comprising:
a chamber configured to receive at least two gas-phase reactants; and
a mechanical-mixing apparatus within the chamber.

2. The reactor of claim 1 wherein the mechanical-mixing apparatus comprises a fan.

3. The reactor of claim 2 wherein the fan is a turbine fan.

4. The reactor of claim 1 further comprising a separation apparatus within the chamber.

5. The reactor of claim 4 wherein the separation apparatus comprises a coil of tubing traversing the centermost region of the volume of the chamber.

6. The reactor of claim 5 wherein the coil transverses the chamber from an upper portion of the chamber to a lower portion of the chamber.

7. The reactor of claim 5 wherein the coil of tubing is configured to contain a fluid.

8. The reactor of claim 4 wherein the separation apparatus is above the mixing apparatus.

9. The reactor of claim 8 further comprising a shield assembly between the separation apparatus and the mixing apparatus.

10. The reactor of claim 9 wherein:
the chamber comprises a product outlet; and
the separation apparatus and the shield assembly are configured to provide product to the product outlet.

11. The reactor of claim 10 wherein:
the chamber comprises upper and lower portions, the upper portion having at least one reactant inlet and the lower portion having the product outlet;
the separation apparatus comprises a coil of tubing extending vertically from the upper portion of the chamber to at least a centermost region of the chamber;
the shield assembly is laterally aligned both below the separation apparatus and above the mixing apparatus; and
the mixing apparatus is above the product outlet.

12. A reactor comprising:
a chamber configured to receive at least one gas-phase reactant;
a separation apparatus within the chamber; and
a catalyst apparatus within the chamber.

13. The reactor of claim 12 wherein the separation apparatus is coupled to a first portion of an interior wall of the chamber, the separation apparatus extending from the first portion to within the chamber.

14. The reactor of claim 13 wherein:
the separation apparatus defines a space within the chamber; and
the catalyst apparatus is coupled to a second portion of the interior wall of the chamber, the catalyst apparatus extending from the second portion to within the space defined by the separation apparatus.

15. The reactor of claim 14 wherein:
the separation apparatus comprises a coil of tubing, the coil of tubing being configured as a cylinder, the interior volume of the cylinder defining the space; and
the catalyst apparatus extends to within the space defined by the cylinder.

16. The reactor of claim 15 wherein the catalyst apparatus comprises at least one light well, the light well extending from the second portion to within the space defined by the cylinder.

17. The reactor of claim 13 wherein:
the separation apparatus defines a space within the chamber; and
the catalyst apparatus is coupled to a second portion of the interior wall of the chamber, the catalyst apparatus defining a perimeter around the space defined by the separation apparatus.

18. The reactor of claim 17 wherein the separation apparatus comprises a coil of tubing, the coil being configured as a cylinder, the interior volume of the cylinder defining the space; and
the catalyst apparatus defines a perimeter around the space defined by the cylinder.

19. The reactor of claim 18 wherein the catalyst apparatus comprises a plurality of light wells, the perimeter being defined by the plurality of light wells.

20. A reactor assembly comprising:
a base configured to define at least a portion of a reaction chamber volume;
a separation apparatus configured to perform chemical separation within the reaction chamber volume;
a catalyst apparatus configured to perform catalysis within the reaction chamber volume; and
a lid coupled to both the separation and catalyst apparatuses and configured to be removably operably coupled with respect to the base, wherein the lid is configured to be positioned in a first operable position to form a seal with the base and provide the apparatuses at least partially within the reaction chamber volume, and a second operable position wherein at least a portion of the lid is spaced from the base and the apparatuses at least partially removed from the reaction chamber volume.

21. The reactor assembly of claim 20 wherein the separation apparatus is coupled to a first portion of the lid, the separation apparatus extending from the first portion to within the chamber in the first operable position.

22. The reactor assembly of claim 21 wherein:
in the first operable position, the separation apparatus defines a space within the chamber; and
the catalyst apparatus is coupled to a second portion of the lid, the catalyst apparatus extending from the second portion to within the space defined by the separation apparatus.

23. The reactor assembly of claim 22 wherein:
the separation apparatus comprises a coil of tubing, the coil configured as a cylinder, the interior volume of the cylinder defining the space; and
the catalyst apparatus extends to within the space defined by the cylinder.

24. The reactor assembly of claim 23 wherein the catalyst apparatus comprises a light well, the light well extending from the second portion to within the space defined by the cylinder.

25. The reactor assembly of claim 20 wherein:
in the first operable position, the separation apparatus defines a space within the chamber; and
the catalyst apparatus is coupled to a second portion of the lid, the catalyst apparatus defining a perimeter around the space defined by the separation apparatus.

26. The reactor assembly of claim 25 wherein:
the separation apparatus comprises a coil of tubing, the coil being configured as a cylinder, the interior volume of the cylinder defining the space; and
the catalyst apparatus defines a perimeter around the space.

27. The reactor assembly of claim 26 wherein the catalyst apparatus comprises a plurality of light wells, the light wells extending from the second portion and encircling the cylinder.

28. The reactor assembly of claim 20 further comprising a mixing apparatus removably operably coupled to the base.

29. A production process comprising:
combining at least two reactants within a chamber to form a gas-phase reaction mixture;
mechanically mixing the mixture within the chamber to form a product.

30. The process of claim 29 wherein one of the two reactants is a halogenation reagent and the other of the two reactants comprises carbon.

31. The process of claim 30 wherein the halogenation reagent comprises hydrogen.

32. The process of claim 31 the halogenation reagent is HBr.

33. The process of claim 30 wherein the other of the two reactants is an olefin.

34. The process of claim 33 wherein the olefin comprises a halogen.

35. The process of claim 34 wherein the halogen comprises fluorine.

36. The process of claim 35 wherein the olefin comprises vinylidene difluoride.

37. The process of claim 29 wherein:
the at least two reactants comprise HBr and vinylidene difluoride; and
the product comprises bromodifluoroethane.

38. The process of claim 29 further comprising separating the product from the reaction mixture.

39. The process of claim 38 wherein at least a portion of the product is separated from the reaction mixture within the chamber.

40. The process of claim 39 wherein the separating comprises condensing the portion of the product.

41. The process of claim 40 wherein the condensing comprises providing a separation apparatus within the chamber, a temperature of the separation apparatus being higher than the boiling point of the two reactants at the pressure within the chamber.

42. The process of claim 41 wherein the separation apparatus comprises coils of tubing.

43. The process of claim 38 further comprising recovering the portion of the product from the reaction mixture.

44. The process of claim 43 wherein:
the separating comprises condensing the portion of the product; and
the recovering comprises collecting the condensed portion of the product.

45. The process of claim 29 further comprising exposing at least a portion of the reaction mixture to a catalyst.

46. The process of claim 45 wherein the catalyst comprises a catalyst apparatus within the chamber.

47. The process of claim 46 wherein the catalyst apparatus comprises at least one light well.

48. The process of claim 47 wherein the catalyst apparatus comprises a plurality of light wells.

49. The process of claim 47 wherein the light well is configured to provide uv radiation to the reaction mixture.

50. The process of claim 49 wherein the uv radiation is 254 nm.

51. The process of claim 29 further comprising purifying the product.

52. The process of claim 51 wherein the purifying comprises:
washing the product;
drying the washed product; and
distilling the dried product.
